(19) United States
(12) Patent Application Publication
(10) Pub. No.: US 2022/0417327 A1
(43) Pub. Date: Dec. 29, 2022

(54) SENSOR NETWORK ASSEMBLY

(71) Applicant: FRABA B.V., SG HEERLEN (NL)

(72) Inventor: CHRISTIAN LEESER, DUESSELDORF (DE)

(73) Assignee: FRABA B.V., SG HEERLEN (NL)

(21) Appl. No.: 17/761,202

(22) PCT Filed: Sep. 19, 2019
(86) PCT No.: PCT/EP2019/075141

§ 371 Date: Mar. 17, 2022

(51) Int. Cl. H04L 67/12

(52) U.S. Cl. CPC H04L 67/12; H04W 84/18

(57) ABSTRACT

A sensor network arrangement includes at least one sensor device and a base station. The at least one sensor device includes a sensor module which detects a physical quantity and which provides a sensor signal corresponding thereto, an evaluation unit which evaluates the sensor signal and which provides sensor data corresponding thereto, a first wireless data interface which provides a wireless transmission of the sensor data, and at least one energy generator which generates electrical energy to operate the at least one sensor device. The base station includes a second wireless data interface which receives the sensor data transmitted by the first wireless data interface at arbitrary times, a first data storage which stores the sensor data received by the second wireless data interface, and at least one readout data interface which transmits the sensor data stored in the first data storage to an external readout device.

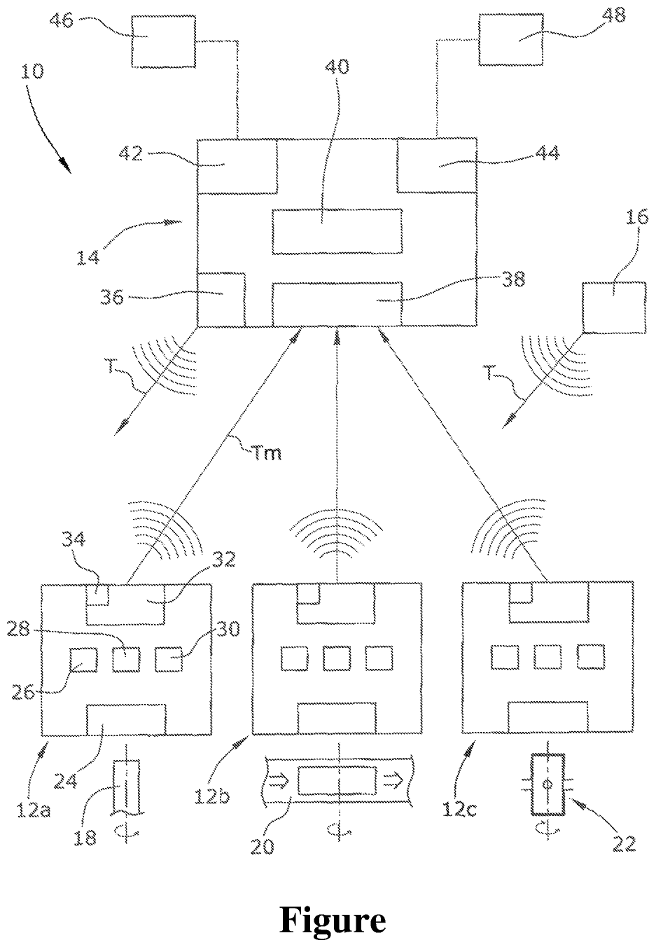

### CROSS REFERENCE TO PRIOR APPLICATIONS

This application is a U.S. National Phase application under 35 U.S.C. § 371 of International Application No. PCT/EP2019/075141, filed on Sep. 19, 2019. The International Application was published in German on Mar. 25, 2021 as WO 2021/052585 A1 under PCT Article 21(2).

### FIELD

The present invention is directed to a sensor network arrangement comprising: at least one sensor device with a sensor module for detecting a physical quantity and for providing a corresponding sensor signal, an evaluation unit for evaluating the sensor signal and for providing corresponding sensor data, and a first wireless data interface for wireless transmission of the sensor data, and a base station with a second wireless data interface for receiving the sensor data transmitted by the first wireless data interface, a first data storage for storing the received sensor data, and at least one readout data interface for transmission of the stored sensor data to an external readout device.

### BACKGROUND

Such sensor network arrangements can be used, for example, in complex industrial systems. The at least one sensor device of the sensor network arrangements can in this case be used, for example, to detect the rotary movement of a machine shaft and/or to detect the flow rate of a gas or liquid line. Any physical quantity can generally be detected by the at least one sensor device, wherein the recorded sensor data can be transmitted from the at least one sensor device to the base station via the wireless data interfaces, and wherein the base station is configured to store the received sensor data in the first data storage. The readout data interface of the base station provides a central access point via which the stored sensor data of the at least one sensor device can be read out by an external readout device at any time.

Such a sensor network arrangement has previously been described, for example, in US 2007/0210916 A1 or US 2007/0281758 A1. The disclosed sensor network arrangements, in particular the data interfaces of the sensor device and of the base station, are configured so that the sensor data transmission takes place periodically, i.e., at predefined transmission times. However, this generally requires an external power supply for both the base station and for the at least one sensor device which ensures that both the base station and the at least one sensor device are switched on at the respective transmission times, and that the wireless data interfaces are ready for use at the transmission times. In the previously described sensor network arrangements, the base station is connected to an external power supply and the sensor devices have a battery for this purpose. Since the disclosed sensor devices consequently require battery replacement at regular time intervals, the disclosed sensor devices cannot be easily mounted at measuring points which are difficult to access, such as, for example, inside a machine/system.

### SUMMARY

An aspect of the present invention is to provide a sensor network arrangement which allows for a simple mounting of the at least one sensor device even at measuring points which are difficult to access and, at the same time, allows for an easy and reliable readout of the recorded sensor data.

In an embodiment, the present invention provides a sensor network arrangement which includes at least one sensor device and a base station. The at least one sensor device comprises a sensor module which is configured to detect a physical quantity and to provide a sensor signal corresponding thereto, an evaluation unit which is configured to evaluate the sensor signal and to provide sensor data corresponding thereto, a first wireless data interface which is configured to provide for a wireless transmission of the sensor data, and at least one energy generator which is configured to generate an electrical energy to operate the at least one sensor device. The base station comprises a second wireless data interface which is configured to receive the sensor data transmitted by the first wireless data interface at arbitrary times, a first data storage which is configured to store the sensor data received by the second wireless data interface, and at least one readout data interface which is configured to transmit the sensor data stored in the first data storage to an external readout device.

### BRIEF DESCRIPTION OF THE DRAWING

The present invention is described in greater detail below on the basis of embodiments and of the drawings in which:

The FIGURE shows a schematic illustration of a sensor network arrangement according to the present invention.

### DETAILED DESCRIPTION

According to the present invention, the at least one sensor device comprises at least one energy generator by which electrical energy for the operation of the sensor device can be generated. The electrical energy generated by the at least one energy generator is sufficient to at least temporarily supply all energy needed for the operation of the sensor device so that the sensor device can operate without an external energy supply. Neither a cable connection with an external energy supply nor a battery, which must be replaced, thus needs to be provided for the operation of the sensor device, which is energy self-sufficient according to the present invention. The energy generator is configured so that electrical energy can be generated at least during operation of the machine/system to be monitored by the sensor device. The energy generator is typically configured to convert mechanical, magnetic and/or electromagnetic energy into electrical energy. The energy generator can, for example, be configured so that an alternating magnetic field can be generated by the rotary movement of the machine shaft to be monitored, via which alternating magnetic field electrical energy can in turn be generated in the sensor device. The sensor device according to the present invention therefore neither requires an external cable connection nor needs the sensor device to be mounted in an easily accessible manner. The sensor network arrangement according to the present invention therefore allows for an easy and thus cost-effective mounting of the at least one sensor device, even at measuring points which are difficult to access.

As soon as electrical energy is generated by the energy generator of the sensor device during operation of the machine/system to be monitored, the sensor device records the sensor data and attempts to transmit the sensor data to the base station via the first wireless data interface. Since the transmission times are in this case unpredictable, the second wireless data interface of the base station is, according to the present invention, configured to receive sensor data from the first wireless data interface of the at least one sensor device at arbitrary times. This means that the second wireless data interface is substantially continuously in a so-called “receive mode” in which the second wireless data interface is waiting for a sensor data transmission from the first wireless data interface. The second wireless data interface can, for example, be configured to continuously receive wireless signals and to analyze the wireless signals for potential sensor data contained in the wireless signal while in receive mode.

This allows for a reliable transmission of the sensor data from the sensor device to the base station even if the sensor device is temporarily without power for a longer undefined period of time while the machine/system to be monitored is stopped. The sensor data transmitted from the sensor device to the base station are stored in the first data storage of the base station and can thus be reliably read out at any time by an external readout device via the readout data interface, in particular even if the at least one sensor device is currently without power. A readout device in this context means, for example, a mobile/portable readout device which can be temporarily connected to the base station as required in order to read out the stored sensor data. A readout device is also, however, explicitly understood to mean a computer system which is connected to the base station via a permanent data connection. The term “readout” in the present context can be understood to mean a readout of the sensor data from the base station by the readout device and can also be explicitly understood to mean an active transmission of the sensor data from the base station to the readout device.

The sensor network arrangement according to the present invention allows for a simple and reliable readout of the sensor data recorded by the at least one sensor device, with the energy self-sufficient sensor device being mountable in a simple manner and thus cost-effectively, in particular even at measuring points which are difficult to access.

In an embodiment of the present invention, the at least one sensor device comprises a Wiegand sensor module via which electrical energy for the operation of the sensor device can be generated. The Wiegand module consequently defines an energy generator according to the present invention. The Wiegand sensor module comprises a so-called Wiegand wire, also known as a pulse wire, and a coil assembly radially surrounding the Wiegand wire. The magnetization direction of the Wiegand wire abruptly reverses under the impact of an excitation magnetic field as soon as a specific trigger field strength is exceeded. This generates a short voltage pulse with a defined electrical energy in the coil assembly. The Wiegand sensor module typically comprises a single pulse wire but can also comprise several pulse wires via which a larger total electrical energy can be generated. The excitation magnetic field is typically generated via permanent magnets arranged at a movable part of the machine/system to be monitored, for example, at a rotatable machine shaft. The frequency of the energy/voltage pulses generated in the Wiegand sensor module is directly proportional to the alternation frequency of the excitation magnetic field and thus to the speed of movement of the moving machine/system part, for example, directly proportional to the rotational speed of the machine shaft. The Wiegand sensor module can thus be used to generate electrical energy for the operation of the sensor device, and, at the same time, to detect the movement of a moving machine/system part. This provides a cost-effective and reliable sensor network arrangement.

The first wireless data interface of the sensor device advantageously comprises an energy converter unit via which electrical energy for the operation of the sensor device can be generated. The energy converter unit consequently defines an energy generator according to the present invention. The energy converter unit is configured to convert the energy of incoming electromagnetic radiation into electrical energy for the operation of the sensor device. The electrical energy which can be generated by the first wireless data interface is typically at least sufficient for proper operation of the first wireless data interface itself so that no electrical energy must be provided to the first wireless data interface from other components of the sensor device for operation of the first wireless data interface. More electrical energy than is required for the operation of the first wireless data interface itself can ideally be generated by the first wireless data interface so that electrical energy for the operation of other components of the sensor device, for example, for the operation of the evaluation unit, can be generated by the first wireless data interface. This provides a particularly reliable sensor network arrangement.

In a particularly advantageous embodiment of the present invention, the at least one sensor device can, for example, comprise an energy storage device in which the electrical energy generated by the Wiegand sensor module and/or the electrical energy generated by the first wireless data interface can be stored. The energy storage allows a short-term operation of the sensor device, for example, for sensor data transmission to the base station, even if there is no excitation magnetic field and thus no energy generation. This provides for a reliable transmission of the sensor data to the base station even if the power supply of the sensor device is interrupted before the sensor data has been transmitted to the base station. The energy storage device can, for example, be a low-cost ceramic capacitor.

In an embodiment of the present invention, the first wireless data interface can, for example, operate according to the principle of modulated backscattering. This means that the first wireless data interface does not generate its own wireless signals, but reflects and thereby modulates an incoming carrier wireless signal, usually by counter-phase field weakening. This requires significantly less electrical energy than actively generating wireless signals. The first wireless data interface can be based, for example, on the known interface standards/specifications “Passive Wi-Fi”, “LoRa Backscatter”, or “RFID”. Electrical energy can, for example, actually be generated by the modulation of the carrier wireless signal in the first wireless data interface, with the generated electrical energy typically being at least sufficient for the operation of the first wireless data interface itself, so that no external energy supply is required for the operation of the wireless data interface. This provides a particularly energy-efficient wireless data interface which provides for a reliable sensor data transmission without any external power supply or with only a relatively small external power supply.

The base station can, for example, (substantially continuously) send out a defined carrier wireless signal which can be modulated by the first wireless data interface. The carrier wireless signal can, for example, be adapted to the configuration of the first wireless data interface and to the spatial conditions, for example, the distance between the at least one sensor device and the base station and/or the presence of any obstacles between the at least one sensor device and the base station. The carrier wireless signal can also be designed for particularly efficient energy generation in the first wireless data interface. This therefore provides for a particularly energy-efficient and reliable sensor data transmission between the at least one sensor device and the base station.

At least one separate wireless sender is advantageously provided which sends out a defined carrier wireless signal which can be modulated by the first wireless data interface. The separate wireless sender provides for a particularly efficient propagation of the carrier wireless signal, in particular even in unfavorable spatial conditions, and thus provides for a particularly reliable sensor data transmission.

In an embodiment of the present invention, the at least one sensor device can, for example, comprise a second data storage for storing the sensor data. The second data storage thus provides for a storing of the sensor data in the sensor device which, in case of a failed sensor data transmission, for example, due to an interruption of the power supply of the sensor device before or during the transmission process, provides for a retransmission of the sensor data. The data storage can, for example, be a non-volatile data storage, for example, a ferroelectric storage, so that the sensor data can be read out even after an interruption of the power supply. This provides a particularly reliable sensor network arrangement.

In an embodiment of the present invention, the base station can, for example, comprise at least one wireless readout data interface so that neither a cable connection nor direct access to the base station needs to be provided for reading out the sensor data stored in the base station. This provides a sensor network arrangement which can be used in a versatile and variable manner.

The base station can, for example, comprise several different readout data interfaces so that the base station can be read out via different readout devices. This provides a sensor network arrangement which can be used in a particularly versatile and variable manner.

An embodiment of a sensor network arrangement according to the present invention is described below with reference to the enclosed drawing which shows a schematic illustration of a sensor network arrangement according to the present invention.

The FIGURE shows a sensor network arrangement 10 with three energy self-sufficient sensor devices 12a, 12b, 12c which are arranged at three different measuring points of an industrial system (which is not shown in greater detail), a base station 14, and a wireless sender 16.

The wireless sender 16 in the present embodiment sends out a defined carrier wireless signal T.

The first sensor device 12a is, for example, a first rotary encoder for detecting rotary movement of a machine shaft 18, the second sensor device 12b is, for example, a fluid flow rate measuring assembly for detecting fluid flow rate in a fluid line 20, and the third sensor device 12c is, for example, a second rotary encoder for detecting rotary movement of a rotary slide valve 22.

The common features of the three sensor devices 12a, 12b, 12c are described below in general for all three sensor devices 12a, 12b, 12c using reference signs without an index and are exemplarily shown in the FIGURE using the first sensor device 12a.

Each sensor device 12 comprises a sensor module 24, each of which is, in the present embodiment, a Wiegand sensor module via which an alternating excitation magnetic field can be detected. The sensor module 24 provides a sensor signal which is proportional to the alternation frequency of the detected excitation magnetic field. Based on the so-called Wiegand effect, the sensor module 24 embodied as a Wiegand module can also generate electrical energy for the operation of the respective sensor device 12 in the present embodiment.

In the present embodiment, each sensor device 12 comprises an energy storage 26 in which the electrical energy generated by the sensor module 24 is temporarily stored.

Each sensor device 12 also comprises an evaluation unit 28 which evaluates the typically analog sensor signal and provides corresponding digital sensor data. The evaluation unit 28 in the present embodiment is powered exclusively by the electrical energy stored in the energy storage 26.

Each sensor device 12 in the present embodiment comprises a non-volatile second data storage 30 which is powered exclusively by the electrical energy stored in the energy storage 26 and in which the sensor data provided by the evaluation unit 28 is stored.

Each sensor device 12 also comprises a first wireless data interface 32 for transmission of the recorded sensor data to the base station 14. The first wireless data interface 32 in the present embodiment operates according to the principle of modulated backscattering with the incoming carrier wireless signal T being modulated by the first wireless data interface 32 so that a defined modulated carrier wireless signal Tm is backscattered. The first wireless data interface 32 in the present embodiment operates according to the well-known “LoRa backscatter” specification. The first wireless data interface 32 in the present embodiment comprises an energy converter unit 34 via which the energy of the incoming carrier wireless signal T can be converted into electrical energy for the operation of the sensor device. The electrical energy generated by the energy converter unit 34 is usually at least sufficient for operation of the first wireless data interface 32. The energy converter unit 34 ideally generates more electrical energy than is required for operation of the first wireless data interface 32, with the excess electrical energy being supplied to the energy storage device 26.

Each sensor device 12 of the sensor network arrangement 10 according to the present invention is completely energy self-sufficient, i.e., the sensor device 12 does not require any external energy supply. In the present embodiment, all of the electrical energy required for the operation of the sensor device 12 is generated entirely by the Wiegand sensor module 24 and by the energy converter unit 34 of the first wireless data interface 32, wherein the generated electrical energy can be temporarily stored in the energy storage 26.

The base station 14 in the present embodiment comprises a wireless sender unit 36 which also sends out the carrier wireless signal T which can be modulated by the first wireless data interface 32 of the sensor device.

The base station 14 also comprises a second wireless data interface 38 for receiving the sensor data which is transmitted by the first wireless data interface 32 of the sensor device 12. The second wireless data interface 38 in particular receives the modulated carrier wireless signal Tm, which is backscattered by the first wireless data interface 32, and evaluates it according to the “LoRa Backscatter” specification, which is used in the present embodiment to determine the sensor data which is transmitted by the sensor device 12. The second wireless data interface 38 is substantially continuously in a receive mode for this purpose in which incoming wireless signals are received and analyzed. The modulated carrier wireless signal Tm, which is provided by the first wireless data interface 32 of the sensor device 12 at an arbitrary (not predefined) transmission time, is consequently reliably received and analyzed accordingly. The second wireless data interface 38 is consequently configured to receive sensor data from the first wireless data interface 32 of the sensor device 12 at arbitrary transmission times.

The base station 14 also comprises a, for example, non-volatile, first data storage 40 in which the sensor data received by the second wireless data interface 38 is stored. In addition to the stored sensor data, it is also recorded in the present embodiment via which of the three sensor devices 12 the respective sensor data was received, so that all stored sensor data can be unambiguously assigned to a specific sensor device 12.

The base station 14 in the present embodiment also comprises two readout data interfaces 42, 44, wherein the first readout data interface 42 is wire-based, and wherein the second readout data interface 44 is a wireless radio readout data interface.

The first readout data interface 42 in the present embodiment provides a data connection with a server computer system 46 via which the sensor data stored in the first data storage 40 can be read out by the server computer system 46 at any time.

The second wireless data interface 44 in the present embodiment can be used to provide a wireless data connection with a mobile readout device 48, via which wireless data connection the sensor data stored in the first data storage 40 can be read out by the mobile readout device 48 and/or transmitted to the mobile readout device 48 as required.

The present invention is not limited to embodiments described herein; reference should be had to the appended claims.

### LIST OF REFERENCE NUMERALS

10 Sensor network arrangement
12 Sensor device
12a First sensor device
12b Second sensor device
12c Third sensor device
14 Base station
16 Wireless sender
18 Machine shaft
20 Fluid line
22 Rotary slide valve
24 Sensor module
26 Energy storage
28 Evaluation unit
30 Second data storage
32 First wireless data interface
34 Energy converter unit
36 Wireless sender unit
38 Second wireless data interface
40 First data storage
42 First readout data interface
44 Second readout data interface
46 Server computer system
48 Mobile readout device
T Carrier wireless signal
Tm Modulated carrier wireless signal

What is claimed is:

1-10. (canceled)

11: A sensor network arrangement comprising:
at least one sensor device comprising,
a sensor module which is configured to detect a physical quantity and to provide a sensor signal corresponding thereto,
an evaluation unit which is configured to evaluate the sensor signal and to provide sensor data corresponding thereto,
a first wireless data interface which is configured to provide for a wireless transmission of the sensor data, and
at least one energy generator which is configured to generate an electrical energy to operate the at least one sensor device; and
a base station comprising,
a second wireless data interface which is configured to receive the sensor data transmitted by the first wireless data interface at arbitrary times,
a first data storage which is configured to store the sensor data received by the second wireless data interface, and
at least one readout data interface which is configured to transmit the sensor data stored in the first data storage to an external readout device.

12: The sensor network arrangement as recited in claim 11, wherein at least one of the at least one energy generator is a Wiegand sensor module.

13: The sensor network arrangement as recited in claim 12, wherein the Wiegand sensor module is the sensor module.

14: The sensor network arrangement as recited in claim 11, wherein,
the first wireless data interface comprises an energy converter unit, and
at least one of the at least one energy generator is the energy converter unit.

15: The sensor network arrangement as recited in claim 11, wherein the at least one sensor device further comprises an energy storage which is configured to store the electrical energy generated by the at least one energy generator.

16: The sensor network arrangement as recited in claim 11, wherein the first wireless data interface is further configured to operate according to a modulated backscattering principle.

17: The sensor network arrangement as recited in claim 16, wherein the base station is configured to send out a defined carrier wireless signal which is modulatable by the first wireless data interface.

18: The sensor network arrangement as recited in claim 16, further comprising:
at least one separate wireless sender which is configured send out a defined carrier wireless signal which is modulatable by the first wireless data interface.

19: The sensor network arrangement as recited in claim 11, wherein the at least one sensor device further comprises a second data storage which is configured to store the sensor data.

20: The sensor network arrangement as recited in claim 11, wherein the at least one readout data interface comprises at least one wireless readout data interface.

21: The sensor network arrangement as recited in claim 11, wherein the at least one readout data interface comprises a plurality of different readout data interfaces.
